(19) United States
(12) Patent Application Publication
(10) Pub. No.: US 2017/0080407 A1
(43) Pub. Date: Mar. 23, 2017

(54) YTTRIUM-CONTAINING CATALYST FOR HIGH-TEMPERATURE CARBON DIOXIDE HYDRATION, COMBINED HIGH-TEMPERATURE CARBON DIOXIDE HYDRATION, AND REFORMING AND/OR REFORMING, AND A METHOD FOR HIGH-TEMPERATURE CARBON DIOXIDE HYDRATION, COMBINED HIGH-TEMPERATURE CARBON DIOXIDE HYDRATION AND REFORMING AND/OR REFORMING

(71) Applicant: BASF SE, Ludwigshafen (DE)

(72) Inventors: Stephan A. SCHUNK, Heidelberg-Rohrbach (DE); Ekkehard SCHWAB, Neustadt (DE); Andrian MILANOV, Mannheim (DE); Guido WASSERSCHAFF, Neckargemuend (DE); Thomas ROUSSIERE, Speyer (DE); Andreas STRASSER, Neckarsteinach (DE); Carlos LIZANDARA, Heidelberg (DE); Nussloch MUELLER, Nussloch (DE)

(73) Assignee: BASF SE, Ludwigshafen (DE)

(21) Appl. No.: 15/126,217

(22) PCT Filed: Mar. 11, 2015
(86) PCT No.: PCT/EP15/55022

§ 371 Date: Sep. 14, 2016

(30) Foreign Application Priority Data
Mar. 14, 2014 (EP) 14159991.0
Dec. 16, 2014 (EP) 14198192.8

(51) Int. Cl. B01J 23/83; B01J 35/10; C10G 2/00; B01J 23/00; C01B 3/40

(52) U.S. Cl. CPC B01J 23/83; B01J 23/002; C01B 3/40; C10G 2/50; B01J 35/1009; C01B 2203/1241; C01B 2203/0238; C01B 2203/1076; C01B 2203/1058; C01B 2203/1052; C01B 2203/1047

(57) ABSTRACT

The invention relates to a process for producing a catalyst for the high-temperature processes (i) carbon dioxide hydrogenation, (ii) combined high-temperature carbon dioxide hydrogenation and reforming and/or (iii) reforming of hydrocarbon-comprising compounds and/or carbon dioxide and the use of the catalyst of the invention in the reforming and/or hydrogenation of hydrocarbons, preferably methane, and/or of carbon dioxide. To produce the catalyst, an aluminum source, which preferably comprises a water-soluble precursor source, is brought into contact with an yttrium-comprising metal salt solution, dried and calcined. The metal salt solution comprises, in addition to the yttrium species, at least one element from the group consisting of cobalt, copper, nickel, iron and zinc.

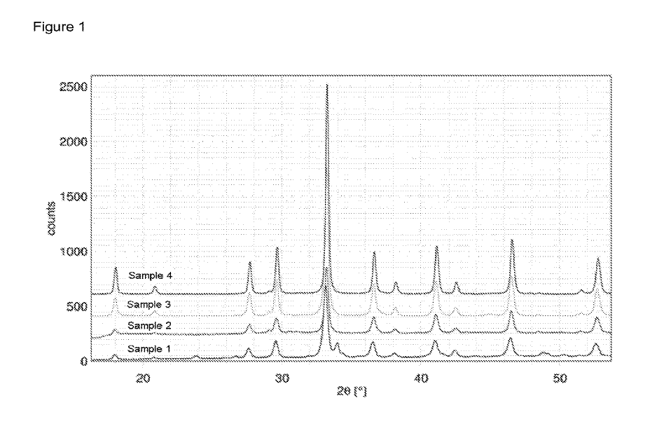

The invention relates to a process for producing a catalyst for the high-temperature processes (i) carbon dioxide hydrogenation, (ii) combined high-temperature carbon dioxide hydrogenation and reforming and/or (iii) reforming of hydrocarbon-comprising compounds and/or carbon dioxide and the use of the catalyst of the invention in the reforming and/or hydrogenation of hydrocarbons, preferably CH₄, in the presence of Co₂. To produce the catalyst, an aluminum source, which preferably comprises a water-soluble precursor source, is brought into contact with an yttrium-comprising metal salt solution, dried and calcined. The metal salt solution comprises, in addition to the yttrium species, at least one element from the group consisting of Co, Cu, Ni, Fe, Zn.

The reforming of methane and carbon dioxide is of great economic interest since synthesis gas can be produced by means of this process. Synthesis gas forms a raw material for the preparation of basic chemicals. Furthermore, the utilization of carbon dioxide as starting material in chemical syntheses is of significant importance for binding carbon dioxide, which is formed as waste product in numerous processes, in a chemical way and thus avoiding emission into the atmosphere.

In keeping with its great economic importance, the reforming of hydrocarbons in the presence of carbon dioxide forms the subject matter of numerous publications. A brief overview of the focal points of some selected publications from the prior art will be given below.

The prior art relating to steam reforming and partial oxidation is indicated below:

Liu and He describe the use of yttrium-comprising catalysts (International Journal of Hydrogen Energy 36 (2011) pages 14447-14454) for the steam reforming of methane. The production of these catalysts was effected by gelling of Y- and Ni-comprising aqueous solutions. Use of Al is not disclosed. The nickel oxide- and yttrium oxide-comprising materials obtained here were used for testing in the steam reforming of methane, with testing being carried out under atmospheric pressure.

In WO 2001/36323, the inventors describe the use of cobalt-comprising catalyst systems for the catalytic partial oxidation of methane to produce a synthesis gas. It is disclosed that cobalt metal or a cobalt-comprising component can be present together with a support, where the cobalt is not structurally incorporated into the support. In a list which includes a large number of support materials, yttrium aluminum garnet is also mentioned. The inventors state, in particular, that in the partial oxidation of methane by means of oxygen in their invention, reactions such as the dry reforming of methane using carbon dioxide can also take place.

In a publication in the year 2010 (Applied Catalysis B: Environmental 97 (2010) pp. 72-81), Le Valant et al. disclose the use of rhodium catalysts which comprise yttrium and nickel and also aluminum in ethanol steam reforming at atmospheric pressure. The supports disclosed do not have a garnet structure. They conclude from their studies that promotion of rhodium with nickel has a positive effect on the overall catalytic performance of the material.

A publication by Shi et al. in the year 2012 (in Applied Catalysis B: Environmental 115-116 (2012) 190-200) reports the effect of various promoters on alumina-supported palladium catalysts, including yttrium in dry reforming. The catalysts described by Shi et al. have a gamma-alumina structure with supported Pd nanoparticles on the surface. The formation of an yttrium- and aluminum-comprising mixed oxide is not reported. The results indicate that yttrium could have a positive effect on target performance since the yttrium-comprising catalysts have improved carbonization resistance.

The prior art relating to the production of garnet is indicated below:

Lu et al. (J. Am. Ceram. Soc., 85 [2] 490-92 (2002)) describe a process for producing polycrystalline garnets, with these being obtained by mixing of the respective metal nitrates with organic acids, intimate mixing, shaping and thermal treatment thereof. Use of the materials in catalysis is not reported.

Innoue (J. Phys.: Condens. Matter 16 (2004) pp. 1291-1303) reports a synthesis of garnet-comprising oxides starting out from glycol-comprising precursor solutions. The use of such compounds in catalysis is not reported.

Sun et al. (Journal of Alloys and Compounds 379 (2004) L1-L3) report an alternative sol-gel process for producing garnets. Here, a synthetic method starting out from aluminum alkoxides and yttrium nitrate, which are subjected to a thermal treatment, is used. The publication gives no pointer to the use of these materials in the field of catalysis.

For the sake of completeness, a brief presentation of the prior art relating to nickel-comprising hexaaluminates will be given below, even though these have no structural relationship to Ni—, Co—, Cu—, Zn— and Fe-comprising garnets. These hexaaluminate-comprising materials which comprise Ni, Co, Fe, Cu, Zn and rare earths are complex crystalline oxides which are part of the prior art in the reforming of methane.

The catalytic properties of nickel-modified hexaaluminates in the reforming of methane and carbon dioxide to form synthesis gas is reported, for example, in a publication by Zhalin Xu et al. (Zhalin Xu, Ming Zhen, Yingli Bi Kaiji Zhen, Applied Catalysis A: General 198 (2000) pp. 267-273). One finding is that the nickel-modified hexaaluminates have a greater activity and better stability than the conventional nickel-comprising catalysts in which the nickel was deposited on the support materials.

A publication by Yokata et al. reports on the use of hexaaluminate-comprising catalysts for synthesis gas production from the reforming of methane in the presence of CO₂ and steam (O. Yokata, T. Tanaka, Z. Hou, T. Yashima; Stud. Surf. Sci. and Cat. 153 (2004) pp. 141-144). The study is based on nickel- and manganese-comprising hexaaluminates, with the manganese-comprising hexaaluminates being able to comprise elements from the group consisting of Ba, La and Sr and also a mixture of Sr_{0.8} La_{0.2}. The catalytic characterization of the catalysts is carried out in the presence of CH₄/H₂O/CO₂ (in a volume ratio of 150/100/50) under atmospheric pressure at a temperature of 700° C. The flow rate is 18 000 hr⁻¹.

J. Wang et al. report the reforming of methane to form synthesis gas using catalysts consisting of nickel-comprising magnetoplumbites which have been doped with cobalt or in which the nickel has been replaced completely by cobalt (J. Wang, Y. Liu, T X. Cheng, W X. Li, Y L. Bi, K J. Zhen, Appl. Catalysis A: General 250 (2003) pp. 13-23). The catalysts disclosed by Wang et al. are described by the empirical formula LaNiₓCo₁₋ₓAl₁₁O₁₉, with a cobalt-lanthanum-comprising hexaaluminate in which x=0 and which is free of nickel also being disclosed. The production of the catalysts disclosed by Wang et al. is based on the use of aluminum nitrate salt which is decomposed together with the remaining metal nitrate salts (i.e. La, Ni and Co or La and Co) in the presence of PEG-isopropyl alcohol. The catalytic reforming experiments are carried out at temperatures up to 800° C. and a GHSV of 9600 hr⁻¹. The nickel-free hexaaluminate catalyst having the composition LaCoAl₁₁O₁₉ displays only a very low activity in respect of the conversion of methane and CO₂ examined. In general, the results of Wang et al. show that the catalytic efficiency of the catalysts is disadvantageously influenced by the addition of cobalt.

In U.S. Pat. No. 7,442,669 B2, D. Wickham et al. disclose an oxidation catalyst which comprises metal-exchanged hexaaluminates. The catalyst has a good catalytic activity and stability at high temperatures, with the activity also being maintained over a prolonged period of time. In general, the catalysts are suitable as oxidation catalysts. In particular, the catalysts are suitable for the treatment of gases from methane combustion, with, in particular, the use in turbines operated using natural gas being of importance. The synthesis of the hexaaluminate-comprising catalysts is based on the use of boehmite particles.

The hexaaluminates disclosed in U.S. Pat. No. 7,442,669 B2 comprise up to three different metal species from the groups M₁, M₂ and M₃. Group M₁ comprises elements from the group of the rare earths, group M₂ comprises elements from the group of the alkaline earth elements and group M₃ comprises elements from the group of the transition metals, with mention being made of Mn, Fe, Co, Ni, Cu, Ag, Au, Rh, Ru, Pd, Ir and Pt. To characterize the catalysts, these were tested in respect of the methane decomposition activity, with the catalysts being exposed to a gas stream comprising 3% by volume of methane. The studies were carried out at a pressure of 5 bar and a GHSV of 17 000 hr⁻¹. As a measure of the efficiency of the catalysts, the temperature T_{1/2} required for converting fifty percent of the methane was determined. The catalysts tested were subjected to different aging profiles before the catalytic tests.

EP 2 119 671 discloses the synthesis of hexaaluminate-comprising catalysts in the presence of template materials. The template materials are advantageous. They influence the formation of particular pore structures. The pore structure of the hexaaluminates produced by means of the process of the invention can thus be controlled.

A large number of publications relate to the use of hexaaluminate-comprising catalysts for the oxidation or partial oxidation of hydrocarbons in the presence of oxygen. When partial oxidations are carried out, very short contact times are desirable in order to prevent total oxidation of the hydrocarbons. For this purpose, it is necessary to carry out the reactions at high flow velocities, a low hydrocarbon concentration and in the presence of oxygen. As illustrative disclosures in the field of partial oxidation, mention may be made of the following disclosures: Kikuchi et al. (R. Kikuchi, Y. Iwasa, T. Takeguchi, K. Eguchi; Applied Catalysis A: General 281 (2005) pp. 61-67), G. Groppi (Applied Catalysis A: General 104 (1993) pp. 101-108.

In general, various processes for producing hexaaluminate-comprising catalysts have been published in the prior art, but all these are characterized by the corresponding starting components being subjected to a thermal treatment at temperatures of 1200° C. and above.

For example, S. Nugroho et al. describe the preparation of phase-pure barium hexaaluminate which has been obtained by heat treatment of barium oxide and aluminum oxide (i.e. BaO and Al₂O₃) by means of a solid state reaction at temperatures of 1450° C. (see S. Nugroho et al., Journal of Alloys and Compounds, 2010, 502, pp. 466-471). M. Machida et al. (M. Machida et al., Journal of Catalysis, 1987, 103, pp. 385-393) disclose the preparation of phase-pure barium hexaaluminates which are obtained by hydrolysis of the corresponding alkoxides, with these being treated at temperatures of up to 1300° C. The hexaaluminate phases resulting therefrom have surface areas of 11 m²/g.

Chu et al. describe a preparation of barium hexaaluminates by carbonate precipitation (see W. Chu et al., Catalysis Letters, 2001, 74, pp. 139-144). In the thermal treatment, temperatures of 1200° C. were necessary in order to obtain the materials having a high phase purity in respect of the barium hexaaluminate phase. It is reported that the materials have surface areas of 17 m²/g.

Regardless of the above, the prior art also encompasses a publication by F. Yin et al. relating to the preparation of hexaaluminates by means of the combustion of urea (i.e. the urea combustion process), which differs from other disclosures in that the thermal treatment of the starting materials is carried out at a much lower temperature than in the other known processes. F. Yin et al. indicate that the phase-pure hexaaluminate material was obtained even at 500° C. The material obtained had a surface area of 20 m²/g.

US 2007/0111884 Al (Laiyuan Chen et al. and Delphi as applicants) discloses and claims catalyst support materials which comprise hexaaluminates and alumina and are provided with rhodium as active component. To produce the catalyst material, the starting materials are combined with a stoichiometric excess of aluminum-comprising component, so that the synthesis forms not only the hexaaluminate-comprising phase but also alumina as secondary phase. US 2007/0111884 Al discloses hexaaluminates which can comprise various cations, with mention also being made of lanthanum-comprising hexaaluminates which can comprise various divalent cations such as Mg, Ca, Ni, Co, Zn and Fe. To produce the catalyst support materials and catalysts, various processes which differ from one another in respect of the mixing steps used and the thermal treatment steps are disclosed. The catalysts of the invention, which according to the disclosure are all doped with rhodium as active metal, are used in a process for the partial oxidation of petroleum spirit in the presence of oxygen, which is employed to produce a hydrogen-rich gas mixture. In the case of partial oxidation reactions which are used for the reforming of fuels, temperatures in the region of 1000° C. and above can occur and, owing to the high temperatures, it is necessary to develop particularly sintering-resistant catalysts for this purpose.

In his doctoral thesis, Todd H. Gardner describes, in the year 2007, the use of hexaaluminates as catalysts for the partial oxidation of fuels obtained in the middle fraction in the distillation. In particular, lanthanum-comprising, barium-comprising and strontium-comprising hexaaluminates which can comprise various transition metal cations are also described. The focus of the work is the examination of hexaaluminates comprising nickel, cobalt or iron, with the transition metals being present in various ratios and being combined with the cations from the group consisting of Sr, La or Ba, which are likewise present in various ratios. The work is aimed at an examination of pure-phase hexaaluminates. Gardner reports that although phase impurities are not excluded, they would be present only in very small concentrations. To characterize the catalytic properties, the catalysts were used for the partial oxidation of n-tetradecane. The partial oxidations were carried out at a pressure of about 2 bar, a GHSV of 50 000 h⁻¹ and using an oxygen-to-carbon ratio (i.e. O to C) of 1.2.

In a publication by J. Kirchnerova et al. (in Catalysis Letters 67 (2000) pp. 175-181), the criteria for the design of new high-temperature catalysts for catalyzing combustion reactions are described. The publication relates to the production and testing of materials having a Perovskite structure and to materials having a hexaaluminate structure. Here, hexaaluminates comprising Sr, La and Mn (i.e. have the structural formula Sr_{0.8}La_{0.2}MnAl₁₁O₁₉) are described. It should also be mentioned that the use of boehmites as starting substance in the synthesis of the materials is disclosed. A conclusion drawn by Kirchnerova et al. is that those perovskites which have particular transition metals can display activity in catalytic combustion. The catalytic experiments for characterizing the catalysts relate to the oxidation of methane to carbon dioxide in the presence of air, with the methane content being given as 2%.

CN 101306361 A discloses hexaaluminates which are used as catalysts for carrying out reactions for the oxidation of hydrocarbons. As stabilizing elements, the hexaaluminates comprise the cationic species La, Ba or Ca and the hexaaluminates can comprise Cr, Mn, Fe, Co, Ni or Cu as transition metal cations.

Some documents which describe prior arts relating to the reverse water gas shift reaction (RWGS) are indicated below:

US 20070149392 discloses the use of a multicomponent catalyst for an RWGS reaction. Lead oxide, copper oxide and/or zinc oxide on support materials, also platinum on cerium dioxide and supported gold, are described as active metals. The reaction temperature of the RWGS is 400° C.

WO 2001/17674 describes the use of supported copper/zinc catalysts for the RWGS reaction.

The use temperature of these catalysts is in the range 150-300° C.

EP 725 038 describes the use of multicomponent catalysts comprising metals of group VIII and VIa supported on zinc oxide in combination with a metal of group IIIb and IVa. The use of such active compositions up to temperatures of up to 600° C. for the reaction of feed gases having the composition hydrogen:carbon dioxide=1 is described.

EP 601 956 describes the use of commercially available reforming catalysts comprising the active metals nickel, iron, copper and zinc. The materials are said to be advantageous for use at temperatures of from 400 to 800° C. and feed gases having the composition hydrogen:carbon dioxide of from 1.5 to 6.5.

EP 291 857 describes the use of a nickel-based catalyst for the RWGS. The catalyst comprises an aluminum oxide-comprising support material. The use of the catalyst is said to be advantageous for combined reforming and RWGS reaction.

None of the prior art relating to the RWGS reaction mentions garnets as support materials. Accordingly, supported catalysts are used as catalysts in reforming reactions in the prior art. In the prior art on the subject, a support material is generally impregnated with a precursor solution by means of a suitable impregnation process and converted into the active catalyst by subsequent thermal and physicochemical treatment steps (Alvin B. Stiles, Catalyst Manufacture, CRC Press 1995). Intimate contact of the active metal with the support surface is said to be established by means of the application to the support and high dispersion of the active metal is said to be achieved by means of suitable treatment. This procedure is often associated with disadvantages since the small metal particles formed often have a high tendency to sinter and the contact of oxide and metal nanoparticles produced by application to the support often does not lead to the desired intimate contact. One way of avoiding disadvantageous effects on the activity and stability here is to increase the active metal content, but dispersion of the active metal generally suffers greatly in such approaches (Wanke S. E. and Flynn, P. C. (1975) “The sintering of Supported Metal Catalysts” Catal. Rev. Sci. Eng. Vol. 12(1), 93-135; Charles T. Campbell Acc. Chem. Res., 2013, 46 (8), pp. 1712-1719 DOI: 10.1021/ar3003514).

It is an object of the invention to provide an improved catalyst; in particular, the catalyst should have improved activity and/or improved resistance to buildup of carbonaceous deposits; and also the use thereof in an improved process, in particular at temperatures of from 600° C. to 1400° C. and throughputs of from 5000 to 100 000 h⁻¹, for high-temperature carbon dioxide hydrogenation, for combined high-temperature carbon dioxide hydrogenation and reforming and/or reforming. The process for producing these catalysts should be very energy-efficient and resource-conserving. Furthermore, the process for high-temperature carbon dioxide hydrogenation, for combined high-temperature carbon dioxide hydrogenation and reforming and/or reforming should also be suitable for the production of synthesis gas. A further object is for the process of the invention to be suitable for high-temperature carbon dioxide hydrogenation, for combined high-temperature carbon dioxide hydrogenation and reforming and/or for reforming, in particular for combined high-temperature carbon dioxide hydrogenation and reforming of hydrocarbons, in the presence of methane.

A further object of the invention is to identify particularly active catalysts which are able, even at high throughputs, in particular at greater than 10 000 h^{-1.}to convert a feed gas mixture into a composition which is close to the thermodynamically predicted equilibrium. Particularly active catalysts allow the reactor to be made smaller and the capital investment for this part of the plant to be kept low.

The abovementioned and further objects are achieved by provision of a catalyst or catalyst precursor, advantageously for high-temperature carbon dioxide hydrogenation, for combined high-temperature carbon dioxide hydrogenation and reforming and/or reforming, which comprises at least one crystalline material which comprises yttrium and aluminum and has at least one of the following structures from the group consisting of cubic garnet structure, orthorhombic perovskite structure, hexagonal perovskite structure and/or monoclinic perovskite structure (i.e. Y4Al₂O₉) where the catalyst comprises Cu, Fe, Co, Zn and/or Ni, in particular Cu, Fe, Co and/or Ni.

For the purposes of the present invention, “high-temperature processes” are processes at temperatures of >600° C., in particular >600° C. and <1400° C.

In the case of a catalyst precursor, the metal species Cu, Fe, Co, Zn and/or Ni are preferably present as replacements for Y and/or Al atoms within the crystalline material.

In the case of a catalyst, the metal species Cu, Fe, Co, Zn and/or Ni can either (i) be present as replacements for Y and/or Al atoms within the crystalline material or (ii) be present on the surface of the catalyst, preferably in zero-valent form. In the case of variant (ii), Cu, Fe, Zn and/or Ni are preferred. If the metal species Cu, Fe, Co, Zn and/or Ni, preferably Cu, Fe, Zn and/or Ni, are present on the surface of the catalyst, they are preferably present as X-ray-amorphous nanoparticles.

The catalyst of the invention is preferably used for combined high-temperature carbon dioxide hydrogenation and reforming of hydrocarbons in the presence of methane.

The % by weight and mol % indicated below are in each case based on the total catalyst or catalyst precursors; with the balance range being closed over the metals.

In a preferred embodiment, the catalyst of the invention has a Y content in the range 15-80 mol %, preferably 17-70 mol %, more preferably in the range 20-70 mol %.

In a preferred embodiment, the catalyst of the invention has an Al content in the range 10-90 mol %, preferably 20-85 mol % and more preferably in the range 30-80 mol %.

In a preferred embodiment, the catalyst of the invention has a content of the at least one further element from the group consisting of Zn, Cu, Ni, Co, Fe or the sum of a plurality of these elements in the range 0.01-10 mol %, preferably 0.02-7 mol %, more preferably 0.1-5 mol %.

The sum of Y and Al is preferably greater than 80 mol %, more preferably greater than 90 mol % and in particular greater than 95 mol %; the sum of Y and Al is preferably in the range from 80 to 99.99 mol %.

The catalyst or catalyst precursor of the invention for high-temperature carbon dioxide hydrogenation, for combined high-temperature carbon dioxide hydrogenation and reforming and/or reforming comprises at least one crystalline material which comprises at least yttrium, aluminum and oxygen species and comprises at least one component having a cubic garnet structure, orthorhombic perovskite structure, hexagonal perovskite structure and/or monoclinic perovskite structure, where at least part of the yttrium and/or aluminum species within the crystalline material are replaced by at least one species from the group consisting of Cu, Ni, Co, Fe, Zn. The replacement can occur either by means of one of the species from the group consisting of Cu, Ni, Co, Fe, Zn or by two, three, four or five of said species of this group. Preferred combinations are Cu with Zn, Ni with Zn, Co with Zn, Co with Ni, Cu with Ni and/or Cu with Co.

The main phases of (i) Y₃Al₅O₁₂ (YAG) having a cubic yttrium aluminum garnet structure, (ii) YAlO₃ (YAP) having an orthorhombic and/or hexagonal yttrium aluminum perovskite structure and/or (iii) Y₄Al₂O₉ (YAM) having a monoclinic perovskite structure of the catalysts of the invention advantageously have a weight of greater than 51% by weight, preferably greater than 70% by weight, in particular greater than 80% by weight, very particularly preferably greater than 90% by weight, more preferably greater than 95% by weight, more preferably greater than 97% by weight.

The catalyst or catalyst precursors of the invention can comprise, in addition to the main phases composed of (i) Y₃Al₅O₁₂ (YAG) having a cubic yttrium aluminum garnet structure, (ii) YAlO₃ (YAP) having an orthorhombic and/or hexagonal yttrium aluminum perovskite structure and/or (iii) Y₄Al₂O₉ (YAM) having a monoclinic perovskite structure, which are preferably present in the range from 51 to 100% by weight, in particular from 60 to 99% by weight, very particularly preferably from 70 to 97% by weight, at least one secondary phase, where the proportion of the at least one secondary phase is in the range 0-49% by weight (based on the structure-analytically measurable balance range), preferably in the range 1-40% by weight, more preferably in the range 3-30% by weight.

The at least one secondary phase can be, for example, oxides comprising Cu, Zn, Ni, Co and/or Fe and/or oxides of yttrium. For example, the secondary phases are selected from the group consisting of alpha-aluminum oxide, theta-aluminum oxide, YCuO₃, YCoO₃, YNiO₃, cobalt-, iron-, copper-, zinc-, nickel- and yttrium-comprising Ruddelson-Popper phases, YFeO₃, CuAl₂O₃, CoAl₂O₄, NiAl₂O₄, FeAl₂O₄, yttrium-stabilized aluminum oxide and/or yttrium-stabilized aluminum oxide hydroxide, with preference being given to the yttrium-comprising secondary phases.

Greater preference is given to a catalyst or catalyst precursor whose BET surface area is greater than 2 m²/g, more preferably greater than 4 m²/g, even more preferably greater than 8 m²/g and particularly preferably greater than 15 m²/g.

In a preferred embodiment, the catalyst or catalyst precursor of the invention comprises at least one yttrium aluminum garnet as main phase.

Comparison of the composition of the catalyst of the invention which comprises yttrium aluminum garnet with a material which consists entirely of yttrium and aluminum and has a well-formed YAG structure Y₃Al₅O₁₂ (YAG) shows that the catalyst of the invention comprises the catalytically active elements Cu, Ni, Co, Zn and/or Fe, preferably in the YAG lattice, preferably as isomorphic replacements. The Cu, Ni, Co, Zn and/or Fe can be present either on aluminum or yttrium sites, which can lead to a garnet deviating from the ideal composition (Y₃Al₅O₁₂=Y/Al ratio of 3/5).

An explanation of the formation of the catalyst of the invention is that the zinc-, copper-, nickel-, iron- and/or cobalt-comprising species added to the synthesis system are virtually completely, i.e. preferably to an extent of greater than 70% by weight, in particular greater than 80% by weight, very particularly preferably greater than 95% by weight, more preferably greater than 97% by weight, incorporated into the structure of the garnet and hardly any, preferably no zinc, copper, nickel, iron and/or cobalt is available for the formation of the secondary phases. The formation of secondary phases is suppressed and the target phases according to the invention are formed from the aluminum- and yttrium-comprising species. The formation of aluminates, spinels or perovskites of the elements Zn, Cu, Ni, Co and/or Fe or other phases which are not according to the invention that are known to those skilled in the art of the elements Y, Zn, Cu, Ni, Co, Fe and/or Al is preferably less than 15% by weight, in particular less than 10% by weight, very particularly preferably less than 5% by weight; in the ideal case, this formation is entirely avoided. However, the explanation given above is not intended to restrict the invention in any way.

In a preferred embodiment, the catalyst or catalyst precursor comprises at least one noble metal-comprising promoter from the group consisting of Pt, Rh, Ru, Pd, Ir, Au, where the proportion of noble metal-comprising promoters is in the range 0.001-5 mol % based on the catalyst, preferably in the range 0.1-3 mol %.

In a further embodiment, the catalyst or catalyst precursor can also comprise a proportion, preferably less than 15 mol %, in particular less than 10 mol %, very particularly preferably less than 5 mol %, of further cationic species (hereinafter referred to as cationic species I) which are preferably selected from the group consisting of the rare earths, with rare earths such as Ce, La, Pr, Tb, Nd, Eu being particularly preferred. In a preferred embodiment, at least one further metal salt of the group comprising lanthanides, preferably lanthanum, cerium and/or praseodymium, is used.

In a further embodiment, the catalyst or catalyst precursor can also comprise a proportion, preferably less than 3 mol %, in particular less than 1 mol %, very particularly preferably less than 0.5 mol %, of further cationic species (hereinafter referred to as cationic species II) which are preferably selected from the group consisting of Mg, Ca, Sr, Ba, Ga, Be, Cr, Mn.

The catalyst or catalyst precursor of the invention can be produced by means of the following steps:

(i) provision of an aluminum source, preferably in solution, more preferably in aqueous solution, (ii) contacting of the aluminum source with an yttrium-comprising compound and at least one further metal salt of the group consisting of copper, zinc, nickel, cobalt or iron, (iii) intimate mixing of the aluminum source from step (i) with the substances in step (ii), (iv) drying of the mixture, (v) low-temperature calcination of the mixture, (vi) forming or shaping, (vii) high-temperature calcination of the mixture.

When the metal salts are not in the form of dissolved metal salts but instead in the form of a melt during the mixing in step (iii), the components can also be added without solvent. In a further embodiment, a precipitant can also be added to the dissolved components. Suitable precipitants are, inter alia, soluble carbonates such as sodium carbonate or sodium hydrogen carbonate, aqueous ammonia solution and/or soluble hydroxides such as sodium or potassium hydroxide and also mixtures of the precipitants listed and other basic precipitants known to those skilled in the art. In a further embodiment, the precipitant is added as aqueous solution. The invention encompasses, in particular, precipitation processes in which temperature and pH are monitored and/or controlled during the precipitation. Preference is given to a pH in the range 6.5-13, more preferably 7.5-12. In particular, those processes in which the precipitation is carried out at a pH which is greater than 7.5 and is kept constant and at a temperature which is above 20° C., preferably above 25° C., are included. Likewise included in the production process of the invention are treatment steps for washing the precipitated material in order to remove undesirable foreign cations and anions.

In a particularly preferred embodiment, the aluminum source is selected from the group consisting of highly reactive aluminum oxides and hydroxides. The aluminum source preferably contains dispersible primary particles, with a primary particle size of less than or equal to 500 nm being preferred.

Likewise encompassed by the invention is the use of alkoxides, carboxylic acid salts, metal-organic compounds or complexes of the starting compounds of Al, Y, Ni, Co, Fe, Ce, La, Cu, Ga, Zn according to the invention.

In a particularly preferred embodiment, the aluminum source is used as aqueous dispersion having an acidic or basic pH. Particular preference is given to using basic solutions or dispersions comprising polyaluminum chloride as aluminum source. As an example of a basic polyaluminum chloride dispersion, mention may be made of a product which is marketed by BK Giulini under the trade name Giufloc.

One aspect of the invention also relates to the process for producing the catalyst.

Yttrium-Comprising Catalyst/YAG Phase

For the purposes of the present disclosure, the term catalyst or catalyst precursor of the invention comprises yttrium-comprising materials which have a high proportion of YAG phase. This means that the catalyst or catalyst precursor of the invention can, in particular embodiments, also comprise secondary phases. The term YAG phase comprises phases which comprise (i) Y₃Al₅O₁₂ (YAG) having a cubic yttrium-aluminum garnet structure, (ii) YAlO₃ (YAP) having an orthorhombic and/or hexagonal yttrium aluminum perovskite structure and/or (iii) Y₄Al₂O₉ (YAM) having a monoclinic perovskite structure. If the catalyst comprises secondary phases, the proportion of secondary phase is preferably in the range 0-49% by weight, more preferably in the range 1-40% by weight and even more preferably in the range 3-30% by weight. If the phase in question is YAlO3 (YAP) having an orthorhombic or hexagonal yttrium aluminum perovskite structure, it is also possible for the orthorhombic and hexagonal yttrium aluminum perovskite structures to be present side by side.

In a further preferred embodiment, it is also possible for the catalyst or catalyst precursor of the invention to be a material in which the YAG phase is present as main constituent, i.e. preferably in a proportion of greater than 75% by weight, in particular greater than 85% by weight, very particularly preferably greater than 95% by weight, in particular is the phase (i) Y₃Al₅O₁₂ having a cubic yttrium aluminum garnet structure.

The determination of the proportion of YAG-comprising phase can be carried out by diffractometric methods such as X-ray powder diffraction. Analytical methods such as Rietfeld refinement can also be used for the evaluation. When particularly finely divided or nanocrystalline materials are present, the determination of the proportion of YAG phase is carried out by means of an optical analysis using the Kubelka-Munk method. Here, a highly sintered reference sample having the same stoichiometry as the sample to be measured (in respect of the proportion of crystalline phase) is produced and this is then assigned the role of standard sample. The samples to be measured are compared with the standard sample as reference, with the reference having been assigned a value of 100%. The optical analytical method is preferred in the case of nanocrystalline materials when these have very small crystallites whose size is in the range of the wavelength of the incident light. Small coherence lengths (in the case of diffractometric studies using an X-ray wavelength of 0.154 nm) are present particularly when the crystallite sizes are less than 0.5 nm, preferably less than 0.4 and more preferably less than 0.3 nm. Such nanocrystalline materials can appear to be X-ray-amorphous in powder diffraction and crystalline in UV analysis.

Aluminum Source

As aluminum source, it is in principle possible to use all aluminum-comprising starting materials, with a preferred aluminum source being selected from the group: pseudoboehmite, boehmite, gibbsite, bayerite, gamma-aluminum oxide, theta-aluminum oxide, hydrotalcites such as magnesium hydrotalcite, colloidal basic aluminum oxides such as the product “Guifloc” from BK Guilini and other colloidal aluminum sources known to those skilled in the art and also mixtures of these. In particular, the following products from Sasol, inter alia, are included: Disperal and all Disperal grades, Dispal, Pural, Puralox, Catalox, Catapal and also all Pural MG grades.

Without restricting the process of the invention by a particular theory, it is assumed that the surface structure of the highly reactive aluminum oxide or hydroxide source, for example theta-aluminum oxide, gamma-aluminum oxide, pseudoboehmite, boehmite, gibbsite, bayerite and mixtures of the abovementioned and other highly reactive aluminum oxide or hydroxide source, could have a substantial influence on the formation of an active catalyst. The boehmite used preferably consists of dispersible particles, and the primary particle size is preferably in the range below or equal to 500 nm. The term dispersible particles means that the particles which have been dispersed or slurried in water form a stable dispersion and settle out on the bottom of the vessel only after a prolonged period of time (i.e. in the range from hours to days).

The aluminum source is preferably a nanoparticulate aluminum-comprising starting material or colloidal primary particles. As nanoparticulate aluminum-comprising starting materials, it is possible to use, for example, peptized aluminum hydroxides, aluminum oxide hydrates or aluminum oxides. Peptization can be carried out by means of organic acids, for example, acetic acid, propionic acid, or by means of inorganic acids, for example nitric acid or hydrochloric acid. The colloidal particles can be admixed with stabilizers such as surfactants, soluble polymers or salts, or such stabilizers can be used in the production process. The colloidal primary particles can also consist of partially hydrolyzed alkoxides.

The invention likewise encompasses basic aluminum-comprising colloids, and also aluminate solutions or colloids.

In a specific embodiment, it is also possible to use shaped bodies of the abovementioned aluminum oxide and hydroxide sources, which are then brought into contact with the other precursor metal compounds. Examples of such shaped bodies can be, inter alia, pellets, extrudates or granules or other shaped bodies known to those skilled in the art.

The use of a highly reactive aluminum oxide or aluminum oxide hydroxide source has been found to be particularly advantageous since it aids the formation of desirable phases.

As metal compounds, preference is given to using those compounds which are soluble in solvents or fusible in the temperature range up to 250° C. and can be obtained inexpensively and in industrial quantities. Solvents which are preferably used include, inter alia, the following: water, acidic or alkaline aqueous solutions, alcohols such as methanol, ethanol, propanol, isopropanol, butanol, ketones such as acetone or methyl ethyl ketone, aromatic solvents such as toluene or xylenes, aliphatic solvents such as cyclohexane or n-hexane, ethers and polyethers such as tetrahydrofuran, diethyl ether or diglyme, esters such as methyl acetate or ethyl acetate.

Particular preference is also given to soluble salts, complexes or metal-organic compounds as metal compounds. Examples of salts are, inter alia, nitrates, nitrites, carbonates, halides, acetates, octanoates. Examples of complexes are, inter alia, EDTA complexes, complexes with amino acid or amines, complexes with polyols or polyacids, complexes with phosphanes. Examples of metal-organic compounds are, inter alia, acetylacetonates, alkoxides, alkyl compounds, compounds with aromatics, e.g. cyclopentadienyl adducts.

As fusible metal compounds, preference is given to using metal salts which do not decompose during melting or in the case of which decomposition is strongly kinetically inhibited. Examples of such metal salts are, inter alia, nitrates, nitrites, halides, chlorates, bromates, iodates, sulfates, sulfites. Particular preference is given to nitrates, nitrites or salt melts comprising nitrates and nitrites.

Suitable methods for bringing the metal compounds into contact with the aluminum source are, inter alia, impregnation processes in which the metal compounds are dissolved in a suitable solvent which is subsequently removed by drying. Such a drying step can be, in the case of an aluminum source in pulverulent form, carried out by, for example, freeze drying or spray drying. As an alternative, spray granulation can also be carried out or static drying of the composites formed can be carried out. For the purposes of the invention, impregnation is a particularly preferred process.

It is also possible to use precipitation processes for producing the catalyst or the catalyst precursor. Here, all components soluble in an acidic medium are preferably initially charged in aqueous solution and then precipitated by means of a basic precipitant. Typically, the following are initially charged in an acidic medium: aluminum source, yttrium source, optionally a rare earth source, and also at least one element from the zinc, copper, nickel, cobalt and iron source. Precipitation is preferably carried out using an aqueous solution of a basic precipitant, at a pH of above 7.5. The pH and the temperature are preferably monitored and kept constant during the precipitation. The invention likewise encompasses the addition of organic auxiliaries to the synthesis system. The organic auxiliaries make it possible to influence the precipitation process so as to obtain a particularly finely divided precipitated material. Suitable auxiliaries are, for example, organic acids, complexing agents and/or surface-active agents such as surfactants in ionic or nonionic form and also water-soluble polymers. Likewise included is contacting of a basic aluminum-comprising solution or dispersion with an acidic solution of all other metal salts, which leads to precipitation. Such a precipitation can occur directly after addition, after thermal treatment and/or concentration.

Further suitable processes for contacting are, inter alia, kneading or milling of an aluminum source in the presence of the yttrium compound and the further metal compound(s), with or without addition of liquids. Kneading, in particular, is a preferred process for the purposes of the invention since it allows coupling with subsequent extrusion and can thus be advantageous for shaping.

For the purposes of the invention, particular preference is given to using metal salts which aid the formation of the YAG phase in the presence of zinc, copper, nickel, cobalt and/or iron for the synthesis.

Such salts are, inter alia, salts of rare earths or lanthanides such as lanthanum and cerium. Further cations which are preferred for the purposes of the invention are those which, like zinc, copper, nickel, cobalt and/or iron, can be incorporated into the YAG. Preference is given to, inter alia, magnesium, calcium, gallium, beryllium, chromium, manganese.

It has completely surprisingly been found that carrying out the high-temperature calcination at relatively low temperatures in the temperature range from 750° C. to 1300° C., preferably in the temperature range from 800° C. to 1200° C., particularly preferably in the temperature range from 850° C. to 1100° C., also leads to catalysts which have very good catalytic performance in the process of the invention for the reforming and/or hydrogenation of hydrocarbons and/or carbon dioxide, in particular in the production of synthesis gas.

Thus, an advantageous temperature window has been found for the high-temperature calcination and the production of the catalyst of the invention, which temperature window ensures a high energy efficiency in the production process and at the same time makes it possible to produce a very effective catalyst for the reforming and/or hydrogenation of hydrocarbons and/or carbon dioxide which displays particularly advantageous performance in respect of the production of synthesis gas.

Carrying out the process for producing the catalyst or the catalyst precursor material in the presence of seed crystals is particularly preferred. Particular preference is given to using seed crystals which have the YAG structure or a similar composition to the target phase. The seed crystals very particularly preferably have a high crystallinity. Particular preference is given to carrying out the process for producing the catalyst or the catalyst precursor material in the presence of seed crystals.

A possible effect which can be achieved by the addition of the seed crystals is lowering of the temperature for formation of the YAG phase when carrying out the process of the invention or increasing the yield of YAG-comprising phase. It can also not be ruled out that both the formation temperature is lowered and the yield is increased. A further advantageous effect related to the addition of seed crystals is a possible shortening of the crystallization time.

As regards the seed crystals, it should be said that these consist, in a preferred embodiment of the process of the invention, of a material comprising YAG, YAP or YAM phase, viz. the targeted product, preferably YAG phase, more preferably greater than 95% by weight of YAG phase, more preferably phase-pure YAG. In addition, preference is given to the seed crystals having a small particle size, preferably less than 500 μm, in particular less than 300 μm, very particularly preferably less than 100 μm, and a high specific surface area, preferably greater than 5 m²/g, in particular greater than 10 m²/g, very particularly preferably greater than 20 m²/g, or consisting of agglomerates having a small crystallite size and a high specific surface area.

Seed crystals can be produced from an appropriate YAG material by subjecting this to a suitable mechanical and/or chemical treatment, for example milling in the dry state, milling in the presence of water or milling in the presence of acids or bases.

In a particularly preferred embodiment, the seed crystals are brought into contact with the aluminum source by intensive mixing. This mixing can be effected by milling, kneading, pan milling or other methods known to those skilled in the art. The mixing of the aluminum source with the seed crystals can be carried out before, during or after contacting with the copper-, zinc-, cobalt-, nickel- and/or iron-comprising compound and the at least one further metal compound.

The aluminum oxide source can be provided either in the form of a solid such as powder or granules or alternatively in liquid form. If the aluminum oxide source is present in liquid form, preference is given to the aluminum-comprising species being dispersed in the solvent or being present as colloidal particles in the latter. The stability of the colloidal alumina or the formation of the colloidal alumina can be improved by selecting a pH which is either in the range from 2 to 4.5 or in the range from 8 to 14. Suitable agents for producing or stabilizing the colloidal alumina are acids such as HNO₃, acetic acid or formic acid or bases such as aqueous NaOH solution, KOH solution or ammonia solution.

In a preferred embodiment of the process of the invention, use is made of a colloidal alumina solution which comprises peptized alumina particles and has a pH in the range from 2 to 4.5.

In a further preferred embodiment of the process of the invention, use is made of an alumina solution which comprises one or more aluminum sources which have been treated with base and has a pH in the range from 8 to 14.

The aluminum source is brought into contact with at least one metal compound. During addition to the aluminum source present as liquid, particular attention is paid to ensure that no precipitation of the metal compounds or the colloids is observed. The addition of the seed crystals can occur before, during or after addition of the metal compounds. As an alternative, the seed crystals can also be added after the drying step.

In a further preferred embodiment of the process of the invention, a dispersible nanoparticulate aluminum oxide source is used as finely divided powder. The finely divided powder consists of primary particles which are smaller than or equal to 500 nm and are present as agglomerates having a D₅₀ of from 1 to 100 μm.

In this preferred embodiment, the aluminum source is brought into contact with at least one metal compound. The metal compound can be added either as solution or as solid. In the case of a solid, a liquid is subsequently added. In the case of the addition of the solution or of the liquid, particular attention is paid to ensuring that a homogeneous, dough-like mass which is kneadable and displays very intimate mixing of the aluminum oxide source and the metal compound is formed. The addition of the seed crystals can occur before or after the addition of the metal compounds. A significant feature of this preferred embodiment is that drying (i.e. step (iv)) precedes extrusion as shaping step (i.e. step (vi)).

In another preferred embodiment of the process of the invention, the finely divided powder of the aluminum source is brought into contact with at least one fusible metal compound. The intimate mixing of the aluminum oxide source and the fusible metal compound is carried out at a temperature in the range from 25° C. to 250° C. In selecting the temperature, particular attention is paid to this being above the melting point of the metal compound. As a result of the melting of the metal compound, a particularly homogeneous distribution of the component in the mixture is achieved. The addition of the seed crystals can occur before, during or after the addition of the metal compounds. As an alternative, the seed crystals can be added only after cooling of the mixture.

The low-temperature calcination of the dried mixture or the molded and dried material which is obtained after the abovementioned process steps basically serves to remove the anions from the metal compounds used and convert the latter into the corresponding metal oxides. The temperature in the calcination depends on the metal compounds used, with the temperature preferably being less than or equal to 550° C. and more preferably in the temperature range from 150° C. to 550° C.

The high-temperature calcination of the molded and dried mixture or the low-temperature calcination of the mixture obtained after process steps as described above are essential process steps in the production of the catalyst of the invention. The temperature of the high-temperature calcination has to be greater than or equal to 750° C., in particular greater than or equal to 800° C.; the temperature is preferably greater than or equal to 850° C. and more preferably greater than or equal to 900° C.

In addition, particular preference is given to carrying out the calcination over a period of time which is greater than 0.5 hour, more preferably greater than 1 hour and in particular greater than 2 hours.

In a further preferred embodiment of the process of the invention, the low-temperature calcination (v) and high-temperature calcination steps (vii) can be carried out in a contiguous process step. This is particularly advantageous when a shaping step precedes the drying step.

If the temperature in the calcination goes below the target temperature of 750° C., production of the catalyst of the invention could be adversely affected since the formation of YAG could possibly fail to occur or an unacceptably small proportion of YAG could be formed. If a calcination temperature above the suitable temperature range is selected, two phases are formed and while these have some catalytic activity, the surface area of the materials is too low. The upper limit for the calcination temperature in the calcination is preferably 1300° C., more preferably 1250° C. and even more preferably 1200° C.

It is conceivable that the invention could be specified further by indication of specific calcination conditions. However, in industrial operation, a very long time for the calcination is uneconomical and undesirable.

A high specific surface area is required for the specific use of the material as catalyst for producing synthesis gas. For the purposes of the invention, in particular materials having surface areas of greater than 2 m²/g are preferred, with particular preference being given to materials having surface areas of greater than 4 m²/g, very particularly preferably materials having surface areas of greater than 8 m²/g, and very particular preference is given to materials having surface areas of greater than 15 m²/g.

A shaping process is important for the production of the catalyst so that the catalyst can be installed in a suitable way in a tube reactor. This is also related to the fact that the colloidally dissolved aluminum hydroxide or the basic aluminum polychloride dispersion which is particularly preferably used as aluminum oxide source is particularly finely divided and has a high reactivity.

A particularly finely divided catalyst material would lead to problems in industrial use. It is therefore also particularly advantageous that very finely divided starting components can be used and are then converted in a molding step into particular catalysts. Direct introduction of a very finely divided catalyst into a tube reactor would lead to a high pressure drop or to complete blockage of the reactor, which would adversely affect the catalytic reforming process.

The material produced by the process of the invention can be used in the form of bulk material, pellets or extrudates in the reforming for producing synthesis gas. The choice of the suitable catalyst form depends on the particular process conditions which prevail and are important for the production of synthesis gas.

Shaping is, according to the invention and preferably, carried out after process steps (iii) or (v); however, it is also conceivable to carry out shaping after process step (vii), although it is not clear whether all properties preferred according to the invention can be achieved in every respect when shaping is carried out only after process step (vii).

The production of a pellet-shaped body is carried out by means of the steps (x.1) compacting, (x.2) sieving and (x.3) tableting. Binders and lubricants can be added to the catalyst material or precursor material used for compacting and tableting. As lubricants, it is possible to use, for example, graphite or stearic acid. Preference is given to using graphite. The amount of lubricant is usually not more than 10% by weight based on the catalyst material.

In addition, it is also possible to produce the target fraction by means of a compacting machine which carries out a plurality of steps in succession. The bulk material produced by means of the compacting machine can possibly have a lower mechanical stability than a material produced by means of a pressing machine.

In addition, it is also possible to produce a shaped body by means of an extrusion step. Such an extrusion operation can be carried out after step (ii) or step (iii) of the production.

However, regardless of the above, it is also possible for the suspension to be dried by means of a spray dryer and subsequently be subjected to a calcination process.

As binder material for compacting and tableting, it is possible to add an oxide or a plurality of oxides to the catalyst. Alternatively, the formation of particular oxides can be controlled during the synthesis by means of specific process features or process steps so as to form the binder during the synthesis. Such process features or process steps can be, inter alia: preferred selection of the stoichiometry of the starting compounds, preferred selection of the type of starting compounds and in particular the aluminum source, preferred selection of the thermal treatment steps. A particularly suitable binder material has a positive effect on the formation of a high surface area of the catalyst of the invention.

Examples of oxides which are formed from the binder material during the calcination and represent particularly preferred secondary phases are, inter alia: theta-aluminum oxide, alpha-aluminum oxide, yttrium aluminate (YAlO3), yttrium-stabilized aluminum oxide, yttrium-stabilized aluminum oxide hydroxide.

In a further embodiment, it is possible, for example, to apply the catalyst or the catalyst precursor material to a ceramic support material by means of a coating process. As support material, it is possible to use a ceramic honeycomb or other shaped bodies.

To produce a particularly active catalyst, it is necessary for the stoichiometry of the elements which form the catalyst material to be in a particular preferred range.

For the purposes of the present discussion, the preferred range of the composition is in each case based on the metallic elements and reported as mol percent. The numbers add up to one hundred parts, with the presence of oxygen not being taken into account.

For the purposes of the invention, preference is given to an yttrium-comprising material whose copper, zinc, nickel, iron and/or cobalt content is preferably in the range 0.01-10 mol %, preferably 0.02-7 mol %, more preferably 0.1-5 mol %.

For the purposes of the invention, preference is given to an yttrium-comprising material which comprises at least one further cationic species (I) selected from the group consisting of rare earths, with rare earths such as Ce, Pr, La, Tb, Nd, Eu being particularly preferred and the content of this at least one cationic species preferably being in the range 0.01-10 mol %, more preferably in the range 0.02-8 mol % and particularly preferably in the range 0.03-5 mol %.

For the purposes of the invention, preference is given to an yttrium-comprising material which comprises at least one further cationic species (II) selected from the group consisting of Mg, Ca, Sr, Ba, Ga, Be, Cr, Mn, with the content of this at least one cationic species preferably being in the range 0.01-10 mol %, more preferably in the range 0.02-8 mol % and particularly preferably in the range 0.03-5 mol %.

In a preferred embodiment, the cationic species of the rare earths is Ce, Pr and/or La. These cationic species (I) are particularly preferably from the group consisting of Ce, Pr and/or La in combination with the cationic species (II) from the group consisting of Mg and Ga, with preference being given, for the purposes of the invention, to the proportion of cationic species being less than 10 mol %, in particular less than 5 mol %, very particularly preferably less than 2 mol %.

Some examples of materials which have a preferred composition are given below:

The catalyst of the invention is distinguished by the fact that it comprises an yttrium aluminum garnet and/or monoclinic yttrium aluminate and that the catalyst comprises yttrium and at least one further element from the group consisting of Cu, Zn, Ni, Co, Fe, where the yttrium content is in the range 15-80 mol %, preferably 17-70 mol % and more preferably in the range 20-70 mol %, the content of the at least one further element from the group consisting of Cu, Zn, Ni, Co, Fe is in the range 0.01-10 mol %, preferably 0.02-7 mol %, more preferably 0.1-5 mol %, and the content of Al is in the range 10-90 mol %, preferably 20-85 mol % and more preferably in the range 30-80 mol %.

Materials which comprise promoters from the group of the platinum metals are likewise included in the invention. In the platinum metal-comprising embodiments, the catalyst materials usually comprise only small amounts of platinum metals. Preference is given to dopings with platinum metals, based on the oxidic material, in the range from 0.1 to 1 percent by weight. Such doping can be effected during the production steps (i) to (v) or (i) to (vi) or in an after-treatment step.

If the catalyst is produced by impregnation with a metal salt solution, the following information may be provided: suitable metal salts are all salts which can be dissolved in a solvent in order to be able to bring about a very homogeneous distribution of the metal species on the surface of the aluminum source, preferably the boehmite.

For example, the metal salts introduced are nitrates or hydrate-comprising nitrates. Water is preferably used as solvent.

The aluminum source preferably comprises only a small amount of nitrate or is nitrate-free. Based on the nitrate content and the total content of all metallic components in the synthesis system (i.e. Al together with Y, Cu, Zn, Ni, Co, Fe and the further metals), the nitrate content is preferably less than 40 mol %, more preferably less than 25 mol % and even more preferably less than 18 mol %.

It is conceivable for noble metal-comprising salts to be added as secondary constituents which act as promoters and lead to an increase in activity of the catalyst to the impregnation solution. However, it should also be taken into account that the use of noble metal-comprising promoters can lead to an increase in the cost of the catalyst. Preferred noble metals for promoting are, inter alia, platinum, rhodium, palladium. The amount of the promoters to be used is advantageously less than 5% by weight, preferably less than 2% by weight, very particularly preferably less than 1% by weight.

As regards the introduction of the noble metal-comprising promoters, it may be said that these can be added during the catalyst synthesis or can be deposited on the finished catalyst.

For the purposes of the invention, the term catalyst precursor describes a material according to the invention which has not yet been subjected to any targeted pretreatment steps (e.g. as described in Technische Katalyse, Jens Hagen, Wiley 1996). The pretreatment is dominant in the utilization of the catalyst material in the process of the invention in which the catalyst material is exposed to feed components of the process. Customary pretreatment steps comprise subjecting the catalyst precursor material to a stream of hydrogen gas, an H₂/N₂ mixture or other reducing or oxidizing species. In particular, the treatment is carried out at elevated temperatures or under hydrothermal conditions; other pretreatment methods are also known to those skilled in the art and can be used here. The catalyst precursor material is usually present in oxidic form. This means that metallic components, e.g. copper, nickel, iron, zinc and cobalt, have an oxidation state of greater than zero.

For the purposes of the invention, the term catalyst describes a material which has been subjected to pretreatment steps. The pretreatment steps are, for example, exposing the catalyst precursor to individual feed components or a plurality of feed components and/or the final feed gas of the process. In this exposure, the catalyst precursor can be converted into the catalyst.

Such pretreatment steps to which such a catalyst has been exposed can include, inter alia, the following steps: treatment with hydrogen, an H₂/N₂ mixture, other reducing or oxidizing agents, in particular at elevated temperatures or under hydrothermal conditions, or other pretreatment methods known to those skilled in the art. Such pretreatment methods can be carried out within or outside the reactor. The pretreatment steps are intended to lead to the catalyst being converted into a state suitable for carrying out the reaction. A physicochemical change in the material occurs here. Such changes can be, inter alia: changes in the texture, changes in the crystallinity, changes in the oxidation states of individual metals or other elements or of a plurality of metals or other elements, formation of metallic nanoparticles, formation of one or more specific catalytically active phases, partial or complete coating with organic compounds or carbonaceous material, complete or partial recrystallization, formation of catalytically active amorphous or partially amorphous surface structures whose composition differs from the bulk material, or other phenomena known to those skilled in the art which can occur during exposure of a catalyst or catalyst precursor. Such physicochemical transformations as described above can generally be measured by analytical methods. However, it is also possible for there to be no significant differences between catalyst and catalyst precursor or for transformations which are not analytically measurable to occur in the context of the present invention.

Catalysis Processes

The fields of use of the catalyst or catalyst precursor of the invention are extremely wide and so the use of the catalyst or of the catalyst precursor is suitable, in particular, for catalytic reforming, for partial catalytic oxidation of hydrocarbons or hydrocarbon-comprising compounds (cPOx), for autothermal reforming (ATR), for dry reforming (DryRef), for high-temperature carbon dioxide hydrogenation and combined high-temperature carbon dioxide hydrogenation and reforming of hydrocarbons in the presence of methane and also, in particular, for producing synthesis gas. Apart from hydrogen, the feed fluid streams advantageously comprise at least one gas from the group consisting of CO₂, CO, O₂, CH₄ and H₂O.

In particular, the invention provides a process for high-temperature carbon dioxide hydrogenation, for combined high-temperature carbon dioxide hydrogenation and reforming and/or for the reforming of hydrocarbons, preferably methane, in which the catalyst or catalyst precursor material of the invention is used, wherein the process preferably comprises the following steps:
(a.1) contacting of a feed gas which preferably comprises hydrocarbons, preferably methane, and optionally hydrogen and/or carbon dioxide with the catalyst of the invention or the catalyst produced by the process of the invention,
(a.2) heating of the reactor or the catalyst present therein during contacting with the reforming gas at a temperature which is greater than 500° C., preferably greater than 700° C., preferably greater than 800° C. and more preferably greater than 850° C.,
(a.3) operation of the reactor while carrying out the reaction at a process pressure which is greater than 1 bar, preferably greater than 5 bar, more preferably greater than 10 bar, particularly preferably greater than 15 bar and more particularly preferably greater than 20 bar,
(a.4) exposure of the catalyst to a gas stream whose GHSV is in the range from 500 to 300 000 hr⁻¹, preferably in the range from 1500 to 200 000 hr⁻¹, more preferably in the range from 2000 to 150 000 hr⁻¹ and more preferably in the range from 2000 to 100 000 hr⁻¹.

In a further preferred embodiment of the process of the invention, the feed gas used in the process comprises more than 40% by volume of hydrogen, carbon dioxide and/or hydrocarbons, preferably methane, preferably more than 50% by volume of hydrogen, carbon dioxide and/or hydrocarbons, preferably methane, and particularly preferably more than 70% by volume of hydrogen, carbon dioxide and/or hydrocarbons, preferably methane. Further components which are comprised in the reforming gas comprise water and/or circulating gases from the processes according to the invention or further downstream processes.

In a further preferred embodiment of the process of the invention, the high-temperature carbon dioxide hydrogenation, the combined high-temperature carbon dioxide hydrogenation and reforming and/or the high-temperature reforming of hydrocarbons is preceded by an activation process. The activation process makes it possible to bring the catalyst to the starting point of the process parameters in a controlled way.

The activation process comprises the thermal treatment of the catalyst in a reducing gas atmosphere at a temperature in the range from 300° C. to 1400° C. The catalyst is preferably heated to the process temperature using a controlled heating process. The heating rate is preferably in the range from 1 ° C/min to 30° C/min, with the range from 5° C/min to 15° C/min being preferred.

The activation process is preferably coupled with a conditioning of the catalyst; the conditioning preferably follows the activation. For the purposes of the present invention, conditioning is an operation in which the catalyst is brought stepwise to the process parameters of the target reaction. This is related to the fact that different conditions may sometimes be necessary for the starting point of the process than for continuous operation. Uncontrolled carbonization of the catalyst during start-up is effectively prevented by the conditioning steps.

The conditioning of the catalyst comprises, for example, heating the catalyst to the process temperature in the presence of carbon dioxide, carbon monoxide, methane, steam and/or hydrogen. It is also possible for the catalyst to be conditioned in the presence of steam.

The feed fluid has a preferred composition in which the total proportion of hydrogen, carbon dioxide and hydrocarbons, preferably methane, is greater than 40% by volume, preferably greater than 50% by volume and in particular greater than 70% by volume. In particular embodiments of the process of the invention, the reforming gas can also comprise carbon monoxide as constituent. In particular embodiments of the process of the invention, the reforming gas can also comprise oxygen and/or water as constituents. In these embodiments, which relate to the use of the catalyst of the invention for carrying out SMR, ATR, cPOx reactions, the proportion of O₂ and H₂O is greater than 5% by volume, preferably greater than 10% by volume and very particularly preferably greater than 20% by volume.

The product of the process is preferably a synthesis gas in the composition range of hydrogen: carbon dioxide in a volume ratio of greater than or equal to one. A preferred ratio of hydrogen to carbon monoxide is in the range from 4:0.1 to 0:1, particularly preferably in the range from 3.5:1 to 0.1:1, very particularly preferably in the range from 3:1 to 0.1:1.

In a particular embodiment, a product gas having a proportion by volume of carbon monoxide of above 90% is produced by the process.

Hydrogen and the carbon dioxide are preferably present in a volume ratio of greater than or equal to one in the feed fluid. A preferred ratio of hydrogen to carbon dioxide is in the range from 5:1 to 1:1, particularly preferably in the range from 4.5:1 to 1:1, very particularly preferably in the range from 4:1 to 1:1.

When the feed fluid comprises hydrocarbon-comprising starting gas, carbon dioxide and the hydrocarbon-comprising starting gas are preferably present in a ratio of greater than 1:1, particularly preferably greater than 4:1, very particularly preferably greater than 5:1.

Steam can be introduced into the feed fluid during the process. The proportion of steam in the feed fluid is preferably equal to or less than 30% by volume, more preferably equal to or less than 20% by volume and even more preferably equal to or less than 15% by volume.

For process engineering reasons, standard gases or auxiliary gases can be added to the feed gas. The standard gas is, for example, a noble gas which is added in a proportion of from 1 to 5% by volume. The addition of an internal standard in laboratory experiments serves to determine the recovery.

In a preferred mode of operation, a synthesis gas having an H₂/CO ratio in the range from 0.85 to 1.4 is produced by means of the process of the invention; the H₂/CO ratio is more preferably in the range 0.9 to 1.2 and even more preferably in the range 0.95 to 1.1.

The process of the invention makes it possible to carry out the process under severe process conditions, in particular at high temperatures and high throughputs, without a significant amount of carbonaceous material being deposited on the yttrium-comprising catalyst. For the purposes of the invention, significant deposition of carbonaceous material is considered to be deposition of more than 2% by weight of carbonaceous material on the catalyst; typically, deposits of carbonaceous material above this value lead to a substantial increase in the pressure drop. The deposition of carbonaceous material is preferably <2% by weight carbon content based on the catalyst used, particularly preferably <1% by weight, more preferably <0.5% by weight, in particular <0.2% by weight. Owing to the very high thermal stability and the operating stability under superatmospheric pressure at pressures of from 5 to 40 bar of the catalyst, this can be used over long times-on-stream of the process, over thousands of hours.

Carrying out reforming at high process pressures, in particular at greater than 5 bar, preferably greater than 10 bar, very particularly preferably at greater than 20 bar, is advantageous because a synthesis gas which is also under a very high pressure is formed. The synthesis gas can be used for further processes in which the synthesis gas has to be present under high pressure as starting material. The presence of a high-pressure gas makes it possible to save a compressor plant and compression steps. The downstream processes can be the synthesis of methanol (50-100 bar), a Fischer-Tropsch synthesis (40-60 bar) or other gas-to-liquid syntheses. The synthesis gas is preferably used for downstream processes in which an H₂/CO ratio which can also be provided in the process of the invention using the yttrium-comprising catalysts is required.

Since the process of the invention makes it possible to provide a synthesis gas which is under a high pressure, the process of the invention is superior to those processes known from the prior art.

### EXAMPLES

### Example 1

Synthesis of Fe—, Co—, Ni— or Cu-modified YAGs having the general composition Y_{2.68}Me_{0.32}Al₅O₁₂ (Me═Fe, Co, Ni or Cu) via the “Gilufloc route” for 30 g of oxidic product in each case

Sample 1: Y_{2 68}Fe_{0.32}Al₅O₁₂

55.976 g of Gilufloc 83 (from Giulini; Al content 12.4% by weight) were weighed into a 600 ml glass beaker and stirred at room temperature on a magnetic stirrer (50 mm stirrer bar, 150 rpm). 53.306 g of yttrium(III) nitrate hexahydrate (from Alfa Aesar, purity 99.9%) and 6.679 g of iron(III) nitrate nonahydrate (from Sigma Aldrich, purity 99.6%) were weighed into a separate glass beaker and dissolved while stirring (magnetic stirrer, 50 mm stirrer bar, 150 rpm) in as little DI water (conductivity after ion exchange 0.5 micro Siemens) as necessary (about 100 ml). After dissolution, the mixture was quantitatively introduced into the Gilufloc 83 while stirring. The glass beaker was rinsed with DI water.

The mixture was covered and stirred at 80° C. (50 mm stirrer bar, 150 rpm) for 2 hours. The mixture was then transferred into flat evaporating dishes (Haldenwanger 888-6a/160 mm diameter).

The filled dishes were placed in a suitable chamber furnace (Nabertherm TH 120/12) and the nitrate decomposition was carried out in a first calcination under synthetic air (CDA) (6 l/min). All hold points were approached at 1K/min and held for one hour (hold points 80° C., 150° C., 200° C., 250° C., 300° C., 350° C. and 450° C.). After the end of the last hold time, the samples were cooled to room temperature (natural cooling of the furnace).

The oxidic intermediate was then removed from the evaporating dishes and brought to the final particle size (315-500 μm). For this purpose, the sample was firstly pressed by means of an agate pestel through a 1000 pm analytical sieve and subsequently through a 500 μm analytical sieve (from Retsch). The fines were then separated off by manual sieving (about 10 seconds) by means of a 315 μm analytical sieve from the target fraction. The fines were retained as reserve samples.

The target fraction is calcined again in order to finish phase formation. For this purpose, the sample was calcined in an AlSint crucible (unglazed Al2O3 crucible from Haldenwanger) in a muffle furnace (M110 from Heraeus) at 900° C. (heating ramp 5K/min) for 4 h under CDA (2 1/min). After cooling of the sample to room temperature, any fines (<315 μm) formed were separated off by renewed sieving.

TABLE 1
Overview of weights used for samples 1-4

| | | Gilufloc | | | | |
|---|---|---|---|---|---|---|
| No. | Composition | 83 | Y(NO₃)₃×6H₂O | Fe(NO₃)₃×9H₂O | Co(NO₃)₂×6H₂O | Ni(NO₃)₂×6H₂O |
| 1 | Y_{2.68}Fe_{0.32}Al₅O₁₂ | 55.976 g | 53.306 g | 6.679 g | — | — |
| 2 | Y_{2.68}Co_{0.32}Al₅O₁₂ | 56.128 g | 53.450 g | — | 4.767 g | — |
| 3 | Y_{2.68}Ni_{0.32}Al₅O₁₂ | 56.135 g | 53.457 g | — | — | 4.85 g |
| 4 | Y₃Co_{0.32}Al_{4.68}O₁₂ | 50.804 g | 57.860 g | — | 4.601 g | — |

TABLE 3
Test procedure for the screening of catalytically active substances
As amount of catalyst, 1 ml was used; the particle size fraction of the material
was 300-500 μm, the internal diameter of the reactor was 5 mm, the length of
the catalytic test zone was 5 cm. The respective phases were supplied with the
appropriate gas compositions for defined times. These were: phase I 48 h, phase
II 48 h, phase III 24 h, phase IV 24 h, phase V 24 h and phase VI 24 h.

| Phase I | | Phase II | | Phase III | |
|---|---|---|---|---|---|
| T [° C.] | 750 | T [° C.] | 750 | T [° C.] | 750 |
| p [barg] | 10 | p [barg] | 10 | p [barg] | 10 |
| GHSV [h−1] | 30000 | GHSV [h−1] | 30000 | GHSV [h−1] | 30000 |
| H2/CO2/CH4 | 2/1/0 | H2/CO2/CH4 | 3/1/0 | H2/CO2/CH4 | 2/1/0.5 |
| CH4-IN [vol. %] | 0 | CH4-IN [vol. %] | 0 | CH4-IN [vol. %] | 13.57 |
| CO2-IN [vol. %] | 31.67 | CO2-IN [vol. %] | 25.75 | CO2-IN [vol. %] | 27.14 |
| H2-IN [vol. %] | 63.33 | H2-IN [vol. %] | 71.25 | H2-IN [vol. %] | 54.29 |

| | | |
|---|---|---|
| Phase IV | Phase V | Phase VI |

| | | | | | |
|---|---|---|---|---|---|
| T [° C.] | 750 | T [° C.] | 750 | T [° C.] | 750 |
| p [barg] | 10 | p [barg] | 10 | p [barg] | 10 |
| GHSV [h−1] | 30000 | GHSV [h−1] | 30000 | GHSV [h−1] | 30000 |
| H2/CO2/CH4 | 2/1/1 | H2/CO2/CH4 | 1/1/0.5 | H2/CO2/CH4 | 2/1/0 |
| CH4-IN [vol. %] | 23.75 | CH4-IN [vol. %] | 19 | CH4-IN [vol. %] | 0 |
| CO2-IN [vol. %] | 23.75 | CO2-IN [vol. %] | 38 | CO2-IN [vol. %] | 31.67 |
| H2-IN [vol. %] | 47.75 | H2-IN [vol. %] | 38 | H2-IN [vol. %] | 63.33 |

TABLE 3
Hydrogen conversion, carbon dioxide conversion, methane yield and methane
conversion data for samples 1-4 compared to the commercial reforming catalyst G1-85 (BASF)
in phase I to VI

| | | Commercial | | | | |
|---|---|---|---|---|---|---|
| | | catalyst | | | | |
| | | G1-85 | Sample 1 | Sample 2 | Sample 3 | Sample 4 |
| | | (BASF) | Y_{2.68}Fe_{0.32}Al₅O₁₂ | Y_{2.68}Co_{0.32}Al₅O₁₂ | Y_{2.68}Ni_{0.32}Al₅O₁₂ | Y₃Co_{0.32}Al_{4.68}O₁₂ |
| Phase I | Conv. H₂[%] | 51.42404 | 29.04 | 38.75 | 52.03 | 50.51 |
| | Conv. CO₂ | 58.3725 | 60.81 | 60.96 | 58.24 | 58.12 |
| | [%] | | | | | |
| | Yield CH₄ | 16.83877 | 0.03 | 7.69 | 16.35 | 16.85 |
| | [%] | | | | | |
| Phase | Conv. H₂ [%] | 48.70494 | 22.91 | 39.82 | 49.37 | 48.50 |
| II | Conv. CO₂ | 68.26528 | 69.58 | 68.96 | 67.84 | 68.03 |
| | [%] | | | | | |
| | Yield CH₄ | 29.36827 | 0.05 | 19.19 | 28.74 | 29.14 |
| | [%] | | | | | |
| Phase | Conv. H₂ [%] | 29.24043 | 29.97 | 32.54 | 30.45 | 30.79 |
| III | Conv. CO₂ | 63.47448 | 62.31 | 62.34 | 63.17 | 62.98 |
| | [%] | | | | | |
| | Conv. CH₄ | −4.79178 | −4.08 | −6.80 | −4.13 | −6.57 |
| | [%] | | | | | |
| Phase | Conv. H₂ [%] | 0 | 29.83 | 23.79 | 16.80 | 17.20 |
| IV | Conv. CO₂ | 0 | 62.67 | 63.93 | 66.47 | 66.05 |
| | [%] | | | | | |
| | Conv. CH₄ | 0 | −1.96 | 2.07 | 7.75 | 6.08 |
| | [%] | | | | | |
| Phase V | Conv. H₂ [%] | 15.08326 | 43.80 | 33.13 | 14.91 | 14.56 |
| | Conv. CO₂ | 45.62 | 47.23 | 50.08 | 55.54 | 54.78 |
| | [%] | | | | | |
| | Conv. CH₄ | 0 | −1.51 | 7.67 | 23.91 | 21.12 |
| | [%] | | | | | |
| Phase | Conv. H₂ [%] | 0 | 32.20 | 46.20 | 52.46 | 50.86 |
| VI | Conv. CO₂ | 0 | 61.25 | 59.65 | 58.23 | 58.31 |
| | [%] | | | | | |
| | Yield CH₄ | 0 | 0.03 | 10.95 | 16.17 | 16.93 |
| | [%] | | | | | |

TABLE 4
Carbon content in the active compositions after
the screening of catalytically active substances

| | Carbon content in % by weight |
|---|---|
| Sample | based on the catalyst used |
| G1-85 | 79.4 |
| Y_{2.68}Fe_{0.32}Al₅O₁₂ | 1.8 |
| Y_{2.68}Co_{0.32}Al₅O₁₂ | <0.1 |
| Y_{2.68}Ni_{0.32}Al₅O₁₂ | <0.1 |
| Y₃Co_{0.32}Al_{4.68}O₁₂ | <0.1 |

### Example 2

Sample 5 was produced in a manner analogous to example 1. The X-ray diffraction analysis of the sample indicated a phase-pure garnet material.

TABLE 5
Overview of the weights used for Sample 5.

| | | Gilufloc | | | | | |
|---|---|---|---|---|---|---|---|
| No. | Composition | 83 | Y(NO₃)₃×6H₂O | Fe(NO₃)₃×9H₂O | Co(NO₃)₂×6H₂O | Ni(NO₃)₂×6H₂O | Cu(NO₃)₂×2.5H₂O |
| 5 | Y_{2.68}Cu_{0.32}Al₅O₁₂ | 55.986 g | 53.314 g | — | — | — | 3.876 g |

The size of the crushed material to be tested was 0.5-1 μm; the total catalyst volume in the reactor was 10 ml, the length of the catalytic zone was 8.85 cm, the internal diameter of the reactor was 12 mm. The test program is shown in Table 6; 8 phases were run, and the length of the respective test phases I to VIII was in each case 24 hours per phase. At the end of phase VIII, the catalyst was removed from the reactor and the carbon content on the catalyst was determined.

TABLE 6
Test procedure for the screening of catalytically active substances.
The reaction conditions are indicated for the respective phase.

| Phase | T [° C.] | H₂:CO₂:CH₄:H₂O | P [barg] | GHSV [h⁻¹] |
|---|---|---|---|---|
| I | 750 | 3,0:1,0:0:0 | 20 | 30000 |
| II | 850 | 3,0:1,0:0:0 | 20 | 30000 |
| III | 950 | 3,0:1,0:0:0 | 20 | 30000 |
| IV | 950 | 3,0:1,0:0:0 | 20 | 40000 |
| V | 950 | 2,0:1,0:0:0 | 20 | 40000 |
| VI | 950 | 2,64:1,0:0,42:0,85 | 20 | 40000 |
| VII | 950 | 3.0:1,0:0,3:0 | 20 | 40000 |
| VIII | 950 | 3,0:1,0:0:0 | 20 | 40000 |

KEY: decimal commas = decimal points

TABLE 7
Hydrogen conversion, carbon dioxide conversion,
methane yield and methane conversion data for
Sample 5 Y_{2.68}Cu_{0.32}Al₅O₁₂ in phase I to VIII

| | | Sample 5 |
|---|---|---|
| | | Y_{2.68}Cu_{0.32}Al₅O₁₂ |
| Phase I | Conv. H₂ [%] | 28.25 |
| | Conv. CO₂ [%] | 69.96 |
| | Yield CH₄ [%] | 0.37 |
| Phase II | Conv. H₂ [%] | 29.91 |
| | Conv. CO₂ [%] | 75.37 |
| | Yield CH₄ [%] | 1.00 |
| Phase III | Conv. H₂ [%] | 28.82 |
| | Conv. CO₂ [%] | 74.90 |
| | Yield. CH₄ [%] | 1.72 |
| Phase IV | Conv. H₂ [%] | 31.65 |
| | Conv. CO₂ [%] | 78.56 |
| | Yield. CH₄ [%] | 2.91 |
| Phase V | Conv. H₂ [%] | 32.54 |
| | Conv. CO₂ [%] | 78.27 |
| | Yield. CH₄ [%] | 2.47 |
| Phase VI | Conv. H₂ [%] | 25.20 |
| | Conv. CO₂ [%] | 65.11 |
| | Conv. CH₄ [%] | 20.10 |
| Phase VII | Conv. H₂ [%] | 33.25 |
| | Conv. CO₂ [%] | 78.88 |
| | Conv. CH₄ [%] | 10.27 |
| Phase VIII | Conv. H₂ [%] | 36.86 |
| | Conv. CO₂ [%] | 78.34 |
| | Yield CH₄ [%] | 2.06 |

TABLE 8
Carbon content in the active compositions after
the screening of catalytically active substances

| | Carbon content in % by weight |
|---|---|
| Sample 5 | based on the catalyst used |
| Y_{2.68}Cu_{0.32}Al₅O₁₂ | <0.1 |

1. A catalyst precursor, comprising at least one crystalline material which comprises yttrium and aluminum and has the characteristic that it has a cubic garnet structure, where the catalyst precursor comprises Cu, Zn, Fe, Co and/or Ni and where part of the yttrium and/or aluminum species in the crystalline material is replaced by at least one element selected from the group consisting of Cu, Zn, Ni, Co, and Fe, where a proportion of secondary phases is in the range from 0-49% by weight.

2. The catalyst precursor according to claim 1, wherein the yttrium content is in the range 15-80 mol % and the aluminum content is in the range 10-90 mol %, where the total content of elements selected from the group consisting of Cu, Zn, Ni, Co, Fe is in the range of 0.01-10 mol %.

3. The catalyst precursor according to claim 1, wherein the catalyst precursor comprises, in addition to a main phase cubic garnet structure, at least one secondary phase present in a proportion in the range of 1-49% by weight.

4. The catalyst precursor according to claim 1, wherein the catalyst precursor has a BET surface area which is greater than 2 m2/g.

5. The catalyst precursor according to claim 1, comprising cubic yttrium aluminum garnet as a main phase.

6. The catalyst precursor according to claim 1, further comprising at least one noble metal-comprising promoter selected from the group consisting of Pt, Rh, Ru, Pd, Ir, and Au, where the content of the at least one noble metal-comprising promoter is in the range from 0.001 to 5% by weight.

7. The catalyst precursor according to claim 1, further comprising at least one cationic species element selected from the group I consisting of Ce, La, Pr, Tb, Nd, and Eu, or the group II consisting of Mg, Ca, Sr, Ba, Ga, Be, Cr, and Mn.

8. The catalyst precursor according to claim 1, comprising nickel, wherein part of the yttrium and/or aluminum in the crystalline material is replaced by nickel.

9. A process for producing the catalyst precursor according to claim 1, comprising:
(i) contacting an aluminum source with an yttrium-comprising compound and at least one further metal salt of an element selected from the group consisting of copper, zinc, nickel, cobalt and iron,
(ii) intimate mixing of the aluminum source which is in contact with the yttrium-comprising compound from,
(iii) drying of the mixture,
(iv) low-temperature calcination of the mixture,
(v) forming or shaping, and
(vi) high-temperature calcination of the mixture.

10. The process according to claim 9, wherein the aluminum source comprises one or more basic solutions or dispersions comprising polyaluminum chloride and/or a nanoparticulate aluminum-comprising starting material.

11. The process according to claim 9, wherein the metal salt is present in the form of a melt during the mixing in (ii).

12. A process for carbon dioxide hydrogenation and/or reforming of hydrocarbons, comprising:
(a.1) contacting of a feed gas which, if carbon dioxide hydrogenation takes place, comprises hydrogen and carbon dioxide and, if reforming takes place, comprises hydrocarbons and carbon dioxide with the catalyst precursor of claim 1,
(a.2) contacting of feed gas with the catalyst present in the reactor occurs at a temperature of ≧600° C.,
(a.3) maintaining a process pressure in the reactor of ≧1 bar during contacting and while the process is carried out, and
(a.4) exposure of the catalyst to a gas stream whose GHSV is in the range from 500 to 100 000 hr⁻¹.

13. The process according to claim 12, wherein methane and carbon dioxide are present in the reforming gas stream, with the ratio of methane to carbon dioxide being in the range from 4:1 to 1:2.
